(19) United States
(12) Patent Application Publication
(10) Pub. No.: US 2026/0099317 A1
(43) Pub. Date: Apr. 9, 2026

(54) CONCURRENT, MULTI-CADENCE UPDATE MANAGEMENT

(71) Applicant: Ivanti, Inc., South Jordan, UT (US)

(72) Inventors: Mitch Berg, Saint Paul, MN (US); David Brylyn, Daresbury (GB); Matthew M. Hazzard, New Brighton, MN (US); David Rolls, Daresbury (GB); Christopher J. Goettl, Owatonna, MN (US)

(73) Assignee: Ivanti, Inc., South Jordan, UT (US)

(21) Appl. No.: 19/268,843

(22) Filed: Jul. 14, 2025

Related U.S. Application Data
(60) Provisional application No. 63/671,666, filed on Jul. 15, 2024.

(51) Int. Cl. G06F 8/65

(52) U.S. Cl. CPC G06F 8/65

(57) ABSTRACT

The present invention relates to a method for managing updates in a managed network environment. The method includes defining a multiple update subroutines, each with a specific n and cadence for activation. These subroutines are implemented concurrently, allowing for a multi-cadence approach to update management. The method leverages a content feed comprising an enumeration of outstanding product updates and associated metadata to determine the activation of the subroutines. This innovative approach ensures that updates are managed efficiently and effectively, catering to the varying needs of different network components and jurisdictions.

### CROSS REFERENCE TO RELATED APPLICATION

This application claims priority to and the benefit of U.S. Provisional Application No. 63/671,666, filed Jul. 15, 2024, which is incorporated herein by reference in its entirety.

### FIELD

The embodiments described in this disclosure are related to update and patch management. In particular, the disclosed embodiments relate to concurrent, multi-cadence update management in managed networks.

### BACKGROUND

In managed networks, update management services are implemented to ensure product updates and software patches are distributed to endpoints. The product updates may include new versions of the products or patches that address vulnerabilities or improve functionality of the products. The update management services can be automated to some extent. In particular, update distribution may be scheduled in some managed networks. An example of a scheduled update distribution in a conventional system might include evaluation of a content feed and distribution of outstanding updates to endpoints. The evaluation and distribution occur at a single cadence. A common cadence is once per month. Accordingly, in these conventional systems, product updates are distributed to the endpoints according to the single cadence, which generally ensures the endpoints have installed the latest versions of the products and that the products are operating properly.

In these conventional systems, the patch management is limited. The update distribution is inefficient and allows vulnerabilities to persist at the endpoints. For instance, in complex managed networks, there may be subsets of products with updates that publish according to different schedules. That is, a first product might have an update release every week while a second product might have an update release every sixty days. Accordingly, a single cadence is either too frequent, which results in unnecessary evaluation, or too infrequent, which results in vulnerabilities persisting at the endpoints. To address these inefficiencies, an administrator may set the particular cadence to address the majority of products and manually evaluate and distribute updates for the remaining products. Additionally, in conventional systems, urgent circumstances are not addressed. For instance, an exploited vulnerability may require immediate or rushed distribution to at least a portion of the endpoints. These circumstances are not addressed in conventional systems, which results in vulnerability persistence or manual distribution by an administrator. Accordingly, a need exists in update management systems to address these inefficiencies and improve update management in urgent circumstances.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes a method of concurrent, multi-cadence update management that may be implemented in a managed network. The method may include defining multiple update subroutines. Each subroutine may include one or more update operations, one or more election criteria that initiate the update operations, and a cadence that determines a frequency at which the subroutine is active in a managed network. The method may include defining a cadence schedule that includes the cadences of the subroutines. The method may include concurrently implementing the subroutines. The concurrently implementing the subroutines may include receiving a content feed. The content feed may include an enumeration or listing of outstanding product updates and/or update metadata that is associated with one or more of the outstanding product updates. The concurrently implementing may include determining whether each of update subroutines is active according to the cadence schedule. This determination may occur at a time in which the content feed is received or within a predetermined period following its receipt. For each of the subroutines that is active, the concurrently implementing may include scanning the content feed for the election criteria identified in the definition of the subroutine. Responsive to the election criteria being present in the content feed, the update operation in the definition of the subroutine may be performed. Responsive to the election criteria not being present in the content feed, the update operation in the definition of the subroutine may not be performed. For each of the subroutines that is not active, the scan operation for the election criteria identified in the definition of the subroutine is not performed.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments described in the present disclosure may be implemented;

FIG. 2A is a block diagram of an example setup phase of concurrent, multi-cadence update management process that may be implemented in the operating environment of FIG. 1;

FIG. 2B is a block diagram of an example implementation phase of the concurrent, multi-cadence update management process;

FIGS. 3A-3C include an example user interface that may be implemented in the setup phase of FIG. 2A;

FIG. 4 illustrates an example computer system configured for concurrent, multi-cadence update management;

FIG. 5 is a flow chart of an example method of concurrent, multi-cadence update management;

FIG. 6 is an example method of update subroutine definition; and

FIG. 7 is an example method of concurrently implementing two or more update subroutines,

all according to at least one embodiment described in the present disclosure.

### DESCRIPTION OF SOME EXAMPLE EMBODIMENTS

The embodiments described in this disclosure are related to update and patch management in managed networks. The disclosed embodiments include systems and methods configured for concurrent, multi-cadence update management in the managed networks. Some embodiments enable definition of multiple update subroutines (hereinafter, “subroutines”). The subroutines are defined through a prescriptive set of rules that enable identification of one or more election criteria, one or more resultant update operations, and a cadence. The subroutines enable improved detection of particular events (e.g., an urgent vulnerability, a malfunctioning product, etc.) and improved response to address the particular events. Additionally, the subroutines enable improved efficiency in managements of complex managed networks having multiple products, multiple jurisdictional endpoint distribution, multiple endpoint groups, or combinations thereof.

The subroutines run concurrently in a managed network. One or more of the subroutines are active according to the defined cadence. When active, one or more of the subroutines performs a scan for the one or more election criteria and performs one or more update operation as necessary. Because the subroutines are prescriptively defined, the subroutines are implemented with minimal or no administrative oversight even in urgent or emergency situations.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

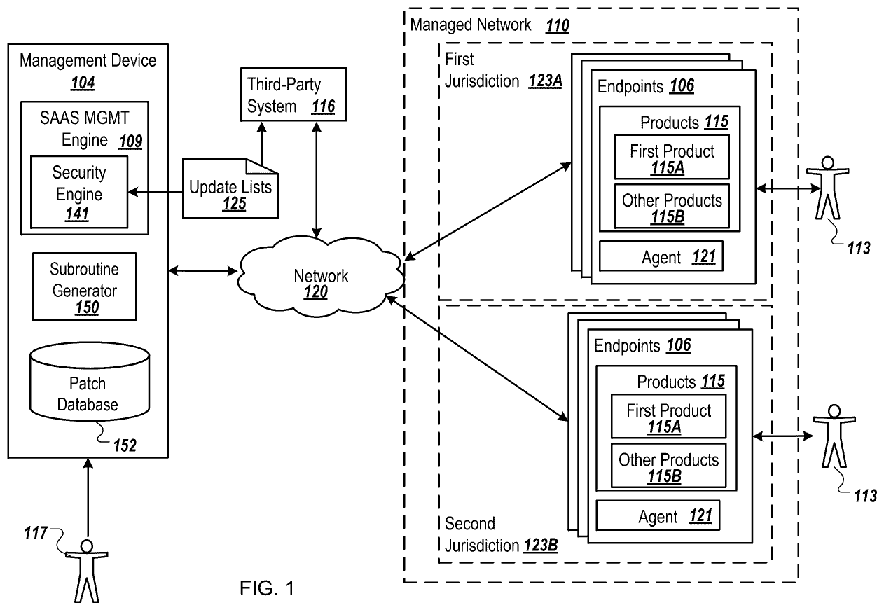

FIG. 1 is a block diagram of an example operating environment 100 in which some examples of the present disclosure can be implemented. The operating environment 100 may be configured for implementation of product update management in a managed network 110. The product update management may enable product updates such as patches and code changes to be accessed, consumed, and distributed to endpoints 106A and 106B (generally, endpoint 106 or endpoints 106) of the managed network 110. In the operating environment 100, management of product updates may be performed according to two or more subroutines that are concurrently implemented. The multiple, concurrently implemented subroutines enable efficient, more secure product update processes.

For example, in some conventional systems, update management may be at least partially automated. For instance, a content feed is received that includes outstanding updates to products (e.g., products 115A and 115B) at one or more endpoints. The content feed populates an update management service. Based on the content feed, outstanding updates may be identified and distributed to the endpoints. However, there are instances and circumstances in which the automated management service fails to address. For instance, in some circumstances, a zero-day vulnerability may be detected. A zero-day vulnerability may include a vulnerability in a product that is disclosed, but not yet patched. Zero-day vulnerabilities are particularly susceptible to exploitation by malicious actors. Accordingly, the speed at which the zero-day vulnerability is patched may be critical. In these conventional systems, there is no automated update process to identify the zero-day vulnerability and to distribute a patch (after it is developed). Accordingly, an administrator may have to manually deploy the patch, which causes additional delays. Moreover, some jurisdictions require the patch to be distributed within a predefined time, which causes an emergency or an urgent situation. As another example, in some managed networks, a first subset of products is updated frequently or more frequently than others. For instance, most products may be updated monthly, while others are updated weekly or every ten days. Accordingly, a single automated update process cannot efficiently update the products in these managed networks with different update frequencies. In these circumstances, either the update management operations are conducted more often than necessary to address the highest update frequency, or some updates (i.e., those directed to the more frequently updated products) are delayed, which may result in vulnerabilities or malfunctioning systems to persist.

Instead of a single, automated patch process as implemented in these conventional systems, in the operating environment 100, multiple subroutines are concurrently implemented. The multiple subroutines automate update management of the managed network 110. For instance, a management device 104 may include a subroutine generator 150 that is configured to define two or more subroutines. Each of the subroutines may be defined to scan for one or more election criteria and implement one or more update operations. The election criteria may be a parameter or characteristic that exists in the managed network 110 or in a content feed. Responsive to the election criteria existing, the update operations defined in the subroutines may be initiated to distribute product updates in a particular way. Additionally, the subroutines may run at one or more cadences. For instance, a first subroutine may run or be active every month, while a second subroutine may be active every day. The subroutines may be defined to address specific circumstances that may exist in the managed network 110. For instance, the first subroutine may be defined to address normal or routine product updates, and the second subroutine may be defined to address critical vulnerabilities. Additional subroutines may be defined and concurrently implemented to address a first product of a set of products 115A and 115B (generally, product 115 and products 115), to address a first vendor of a portion of the products 115, to address an outstanding update with a vulnerability score or a cybersecurity risk. Additionally, the additional subroutines may be defined to address a characteristic or configuration of the managed network 110. For instance, the additional subroutines may be defined to address a device type, an endpoint group, a user group, a jurisdiction/geographic location of some of the endpoints 106, and the like.

The defined subroutines may be communicated to a security engine 141. The security engine 141 is configured to concurrently implement the defined subroutines. Concurrent implementation automates update management services in the operating environment 100. For instance, the security engine 141 may implement the multiple subroutines according to multiple cadences over months or years, which automate update management services relative to the managed network 110.

Accordingly, embodiments of the present disclosure provide a technical improvement to conventional patch management systems. For instance, in the operating environment 100, subsets of the products 115 may be updated according to different cadences, urgent update circumstances may be automated, and these update operations may be optimized for efficiency. Accordingly, delays related to patch distribution may be reduced, manual intervention in update operations may be reduced or eliminated, and the update operations may be customized to the managed network 110 and components thereof.

The embodiments of the present disclosure are directed to a computer-centric problem and are implemented in a computer-centric environment. For instance, the examples of the present disclosure are directed systems and methods configured to define and implement subroutines that scan, analyze, and initiate update package generation and distribution in the managed network 110. Computing processes occurring in the operating environment 100 include communication and implementation of product updates that include software patches and code changes on the products 115 loaded on the endpoints 106. Communications during the processes described in this present disclosure involve the communication of data in electronic and optical forms via a network 120 and also involve the electrical and optical interpretation of the data and information.

The operating environment 100 may include the management device 104, the managed network 110, and a third-party system 116. The managed network 110 includes the endpoints 106. The components of the operating environment 100 are configured to communicate data and information via the network 120 to perform concurrent, multi-cadence update management as described in the present disclosure. Each of these components are described in the following paragraphs.

The network 120 may be comprised of many interconnected computer systems and communication links. The communication links may be hardware links, optical links, satellite or other wireless communications links, wave propagation links, or any other mechanisms for communication of information. Various communication protocols may be used to facilitate communication between the systems of FIG. 1. These communication protocols may include TCP/IP, HTTP protocols, wireless application protocol (WAP), vendor-specific protocols, customized protocols, and others. In one embodiment, the network 120 is at least partially comprised of the Internet, or another communication network including a local area network (LAN), a wide area network (WAN), a wireless network, an intranet, a private network, a public network, a switched network, and combinations of these, and the like.

The third-party system 116 includes a hardware-based computer device or collection thereof that is configured to communicate with the other components of the operating environment 100 via the network 120. The third-party system 116 is configured to provide access to one or more update lists 125, portions thereof, and information pertaining to entries of the update lists 125. For instance, the third-party system 116 may host a website on which the update lists 125 are available. The third-party system 116 may host or store the update lists 125 such that information, metadata, and data related to entries on the update lists 125 may be accessed via the network 120. For instance, the management device 104 may be configured to access the update lists 125 or information related to entries on the update lists 125 via the network 120. In some examples, the management device 104 may be configured to communicate an electronic message to the third-party system 116 that accesses the update lists 125, information (e.g., update metadata) related to entries on the update lists 125, or a specific portion of the update lists 125. Some examples of example APIs for accessing the update lists 125 are available at https://www.circl.lu/services/cve-search/.

The update lists 125 may include a list of entries. The entries relate to a cybersecurity threat, a cybersecurity vulnerability, a software application code change, a patch, a hardware interface modification, or another update to a product such as the products 115. The entries have information related to them. For instance, one or more of the entries may include an identification number, an entry date, an entry summary, a link to product updates (e.g., a code change or patch), a threat severity, vulnerability risk, vendor severity rating, other metadata, or some combination thereof.

An example of the third-party system 116 may be Department of Homeland Security (DHS) server(s). In this example, the update lists 125 may include lists of common vulnerabilities and exposures (CVEs) hosted by the DHS servers. Another example of the third-party system 116 may be National Institute of Standards and Technology (NIST) servers. In this example, the update lists 125 may include national vulnerability database that is hosted by the NIST servers. The NIST server may host the information assurance vulnerability alerts (IAVAs), which may be an example of the update lists 125. One with skill in the art may be familiar with other suitable examples of the third-party system 116 and the update lists 125. Lists of vulnerabilities and threats are maintained by some additional entities such as MITRE.

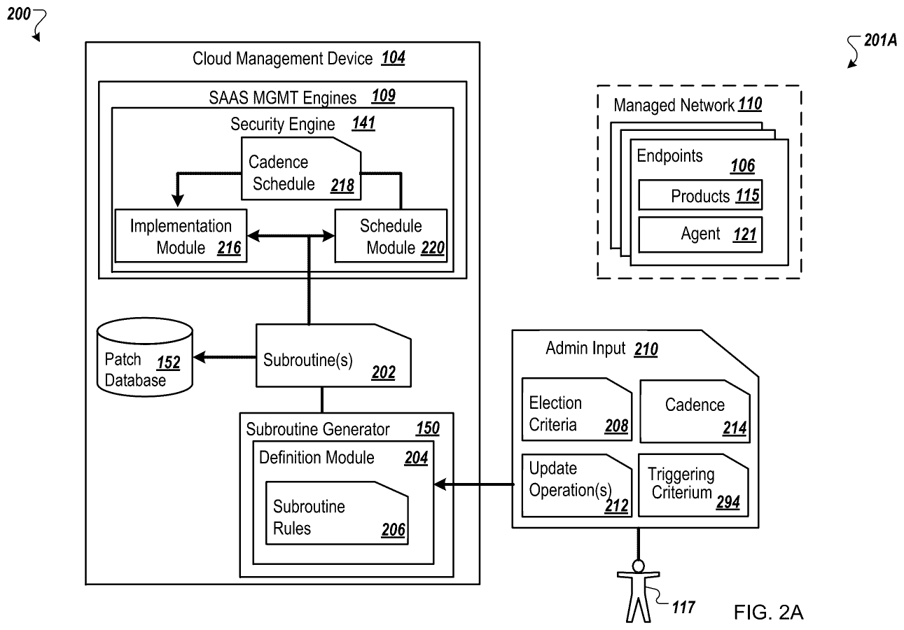

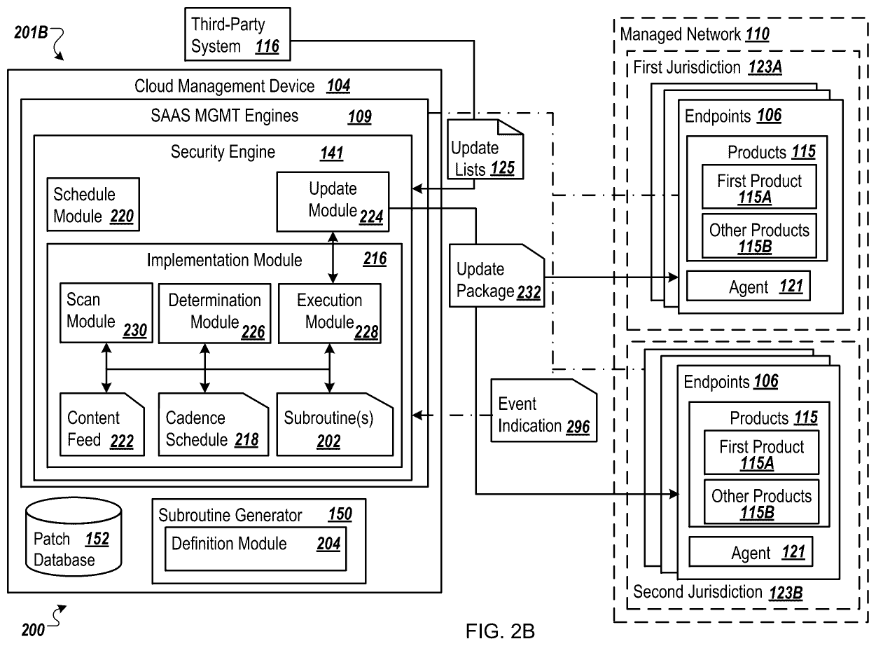

In some embodiments, the update lists 125 may be consumed at the management device 104 to generate a content feed (e.g., content feed 222 of FIG. 2B), which is sometimes referred to as an update or patch catalog. The content feed may be an aggregation of updates included in the update lists 125. In addition to the aggregation of the updates, the content feed may include update files as well as detection and deployment logic used to patch the products 115. The content feed may be used in the security engine 141. For instance, the content feed may populate a user interface that provides visibility to outstanding updates for the products 115 as well as the characteristics and parameters of the outstanding updates.

The content feed includes records and information related to previous product updates (e.g., a code change or patch) as well as outstanding product updates. As the update lists 125 become available, updated metadata or other information may be appended to the content feed. The content feed may be stored at least temporarily at the management device 104 or a patch database 152. In other instances, the content feed may be stored remotely and accessed by the management device 104 via the network 120.

In some examples, the operating environment 100 may include a support device that consumes the update lists 125 and generates the content feed. In these examples, the management device 104 might receive the content feed from the support device.

The managed network 110 includes the endpoints 106. To implement the managed network 110, the endpoints 106 may be enrolled. After the endpoints 106 are enrolled, ongoing management of the endpoints 106 may be implemented by the management device 104. The ongoing management may include overseeing and dictating at least a part of the operations at the endpoints 106 as well as dictate or control product updates (e.g., a code change or patch) implemented at the endpoints 106 as described in the present disclosure. The managed network 110 may be associated with an enterprise, a portion of an enterprise, a government entity, or another entity or set of devices.

The endpoints 106 may include hardware-based computer systems that are configured to communicate with the other components of the operating environment 100 via the network 120. The endpoints 106 may include any computer device that may be managed by the management device 104 and/or have been enrolled in the managed network 110. Generally, the endpoints 106 include devices that are operated by the personnel and systems of an enterprise or store data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines. The endpoints 106 may be referred to as managed endpoints when the endpoints 106 are included in the managed network 110.

The endpoints 106 may be associated with the users 113. The phrase “associated with” when describing the relationship between the endpoints 106 and the users 113 indicates that the users 113 generally or regularly operate the endpoints 106. The users 113 may be assigned a role or may be grouped with one or more other users 113.

The endpoints 106 include the products 115 and an agent 121. The agents 121 may be locally installed at least temporarily on the endpoints 106. For instance, the agents 121 may be installed on the endpoints 106 when the endpoints 106 are enrolled in the managed network 110 or when a particular service is loaded at the endpoints 106. The agents 121 may have access to information related to the products 115 and may be configured to communicate the information such as product metadata related to the products 115 to the management device 104. For instance, the agent 121 may have access to information related to the products 115. On its own or responsive to a request (from the management device 104 or another endpoint 106), the agent 121 may communicate the information related to the products 115 to the management device 104. The information related to the products 115 may include a current inventory of the products 115 as well as information or product metadata related to the products 115 such as version, vendor, type, hardware integrations, size, privacy policy, software interfaces, and the like. The agents 121 may also implement administrative and/or management processes within the managed network 110.

The products 115 may include applications of any kind or type. Some examples of the products 115 may include software applications, enterprise software, operating systems, and the like. The products 115 may differ between endpoints 106. The products 115 may be individually patched or updated. For instance, an update may be distributed to a first product 115A at a first time responsive to a first subroutine. At a second time, updates to other products 115B may be distributed responsive to a second subroutine.

In the managed network 110 of FIG. 1, a first subset of the endpoints 106 may be located in a first jurisdiction 123A and a second subset of the endpoints 106 may be located in a second jurisdiction 123B. The first subset may be subject to different policies than the second subset. For instance, an update deadline for the products 115 in the first jurisdiction 123A may be shorter than the products 115 in the second jurisdiction 123B. Accordingly, an update may be distributed to the first subset in the first jurisdiction 123A responsive to a first subroutine. An update may then be distributed to the second subset in the second jurisdiction 123B responsive to a second subroutine or to a second update operation of the first subroutine. Update distribution based on the jurisdiction 123 may enable the managed network 110 to meet jurisdiction-specific policies.

The management device 104 is configured to manage product updates (e.g., a code change or patch) at the endpoints 106. In general, management of the product updates may include determining which product updates pertain to products 115, to determine which of the product updates to distribute to the endpoints 106, and to distribute the product updates to the endpoints 106 such that the product updates may be locally implemented. Implementation of the product updates at the endpoints 106 include modification to computer code, programming code, or computer-executable instructions of a program that comprise the products 115. In the operating environment 100, the management device 104 may concurrently implement multiple subroutines. The subroutines direct update operations performed by the security engine 141 as described elsewhere in the present disclosure.

The management device 104 may include a hardware-based computer system that is configured to communicate with the other components of the operating environment 100 via the network 120. In some examples, the management device 104 may be a single server, a set of servers, a virtual device, or a virtual server in a cloud-base network of servers. In these and other examples, the security engine 141 and the subroutine generator 150 may be spread over two or more cores, which may be virtualized across multiple physical machines.

The management device 104 may be associated with an administrator 117. The administrator 117 may be an individual, a set of individuals, or a system that interfaces with the management device 104. In some examples, the administrator 117 may provide input such as admin input to the management device 104. The input provided by the administrator 117 may form data and information used to define the subroutines using the subroutine generator 150. Input provided by the administrator 117 may also form the bases of some computing processes performed by the management device 104. The user input may take the form of a selection of an icon or button on the management device 104 in some embodiments.

The management device 104 operates within the managed network 110 to provide management operations to the endpoints 106. To provide the management operations, the management devices 104 includes a SAAS management engine (in the Figures “SAAS MGMT engine”) 109 that is configured to perform one or more management operations relative to the endpoints 106. For instance, the SAAS management engine 109 may ensure the endpoints 106 are up to date, may ensure users 113 of the endpoints 106 have access to products 115 suitable for a role or function, the SAAS management engine 109 may provide technical support to the endpoints 106, and the like. In some embodiments, the SAAS management engine 109 may include a risk-based vulnerability management engine. In these and other embodiments, the risk-based vulnerability management engine may analyze vulnerabilities and outstanding updates to derive vulnerability analytics related to the managed network 110. An example of the risk-based vulnerability management engine is Ivanti® Patch Management. Risk-based vulnerability analytics may be defined as one of the election criteria in a subroutine implemented by the security engine 141 in these and other embodiments.

The management device 104 may also include the subroutine generator 150 and a patch database 152. The subroutine generator 150 may be configured to define subroutines. For instance, the subroutine generator 150 may receive the admin input to at least partially define the subroutines. In some embodiments, the subroutine generator 150 may provide one or more templates or partially defined templates that may be modified or customized by the administrator 117. The subroutine generator 150 may define the subroutines based at least partially on prescriptive rules. The prescriptive rules describe update operations to perform in the managed network 110 such as which of the endpoints 106 to update, which may be based on the jurisdiction 123, a role of an associated user 113, other update operations, or combinations thereof. The update operations may also determine which of the products 115 to update, timing related to distribution of the update, update processes and regimes (e.g., ring deployment, staging, etc.) related to update distribution, other update operations, or combinations thereof.

In addition, the prescriptive rules may describe circumstances or parameters that initiate the update operations. The circumstances or parameters that initiate the update operations are referred to in the present disclosure as election criteria. The election criteria may include a parameter of an outstanding update or of the managed network 110. For instance, the parameter may include the product 115 to which the update is directed, a vulnerability score, a vendor severity score, a risk-based vulnerability analytic, another parameter, or combinations thereof.

The subroutine generator 150 may also define a cadence for the subroutines. The cadence determines a frequency at which the subroutine is active in the managed network 110. Multiple subroutines may include multiple cadences. Some example cadences may include monthly, weekly, and daily cadences. A monthly cadence means that the subroutine is active one time per month. A weekly cadence means that the subroutine is active one time per week. The subroutine generator 150 may define a cadence schedule that includes cadences of the subroutines. The cadence schedule combines the cadences over a period of time. For instance, the cadence schedule might combine the cadences over a quarter and the subroutines may include a first subroutine having a monthly cadence, a second subroutine having a weekly cadence, and a third subroutine having a 45-day cadence. Accordingly, the cadence schedule may include the monthly cadence three times (once per month), the weekly cadence twelve or thirteen times (once per week), and the 45-day cadence twice (once every 45 days). The subroutine generator 150 may communicate the subroutines and the cadence schedule to the patch database 152 and the security engine 141.

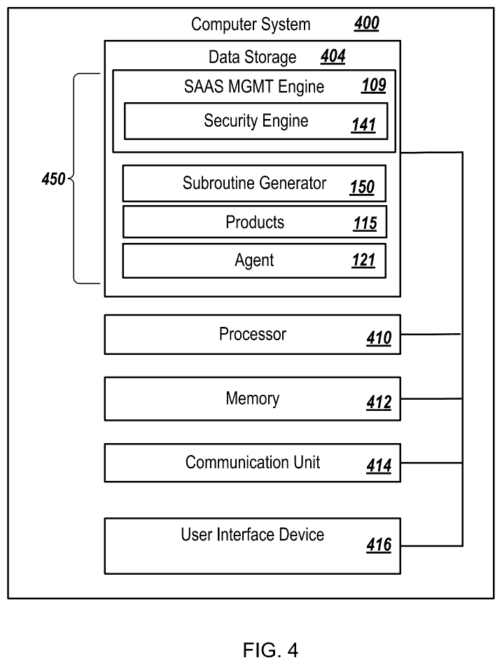

The patch database 152 may include non-transitory storage media (e.g., 412 of FIG. 4). The patch database 152 may be configured to store, at least temporarily, the subroutines and the cadence schedule such that the subroutines may be accessible to the security engine 141.

The security engine 141 may be included in the SAAS management engines 109. The security engine 141 may be configured for automated software management of the endpoints 106 of the managed network 110. In the operating environment 100, the security engine 141 may be configured for concurrent implementation of the subroutines. For instance, the security engine 141 may receive or generate a content feed. The content feed includes an enumeration of outstanding product updates and update metadata associated with one or more of the outstanding product updates. The content feed may be based at least partially on the update lists 125 in some embodiments.

The security engine 141 may determine, at a time in which the content feed is received or at a particular time after receipt of the content feed, whether or which of the subroutines is active according to the cadence schedule. For each subroutine that is active, the security engine 141 may scan the content feed for one or more election criteria identified in the definition of the subroutine. For each subroutine that is not active, the security engine 141 may not initiate a scan operation for the election criteria identified in the definition of the subroutine. Responsive to the election criteria being present in the content feed, the security engine 141 may perform the update operation in the definition of the subroutine. Responsive to the election criteria not being present in the content feed, the security engine 141 may not perform the update operation in the definition of the subroutine.

The agent 121, the subroutine generator 150, the security engine 141, the products 115, and components thereof may be implemented using hardware including a processor, a microprocessor (e.g., to perform or control performance of one or more operations), a field-programmable gate array (FPGA), or an application-specific integrated circuit (ASIC). In some other instances, the agent 121, the subroutine generator 150, the security engine 141, the products 115 and components thereof may be implemented using a combination of hardware and software. Implementation in software may include rapid activation and deactivation of one or more transistors or transistor elements such as may be included in hardware of a computing system (e.g., the endpoints 106 or the management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more management devices 104, one or more endpoints 106, one or more third-party systems 116, or any combination thereof. Moreover, the separation of various components and devices in the examples described herein is not meant to indicate that the separation occurs in all examples. Moreover, it may be understood with the benefit of this disclosure that the described components and servers may generally be integrated together in a single component or server or separated into multiple components or servers.

FIGS. 2A and 2B are a block diagram of an example concurrent, multi-cadence update management process (process) 200 that may be implemented in the operating environment 100 of FIG. 1 or another suitable system. The process 200 is separated into a setup phase 201A of FIG. 2A and an implementation phase 201B of FIG. 2B. FIGS. 2A and 2B include components (e.g., 104, 109, 106, 152, 150, 110, and 106). Description of these components are not repeated with reference to FIGS. 2A and 2B. Although not shown in FIGS. 2A and 2B, communication of data and information may be via a network such as the network 120 of FIG. 1.

FIG. 2A is a block diagram of an example setup phase 201A of the process 200. During the setup phase 201A, two or more subroutines 202 may be defined. For instance, in the depicted embodiment, the administrator 117 may provide admin input 210 to the subroutine generator 150, which may be used to define the subroutines 202. Additionally, in some embodiments, one or more parameters of the subroutines 202 may be provided or a template of one of the subroutines 202 may be provided, which may be selected.

Generally, each of the subroutines 202 includes one or more update operations 212, one or more election criteria 208, and a cadence 214. Essentially, each of the subroutines 202 defines what circumstance or conditions exist, which are referred to as the election criteria 208, that initiate a particular distribution of a product update, which are referred to as the update operations 212, and how often those conditions are searched for, which is referred to as the cadence 214.

For example, the update operations 212 are actions or selections taken relative to the endpoints 106 or portion thereof to implement product updates at one or more of the products 115. For instance, the update operations 212 may include a selection or identification of a subset of the endpoints 106 that are update according to one of the subroutines 202, a specification of a jurisdiction in which the endpoints 106 are updated, whether a product update is distributed according to a ring deployment process, a reboot operation, timing regarding the update distribution or publication, other update operations, or combinations thereof.

The election criteria 208 include the circumstances or conditions or combinations thereof that initiate the update operations 212. For instance, the subroutine 202 is defined to look or search for the election criteria 208. In response to the election criteria 208 existing at the time of the search, the update operations 212 are initiated. The election criteria 208 may relate to a subset of the products 115, a characteristic of a product update, a subset of the endpoints 106, a jurisdiction or a geographic location in which a subset of the endpoints 106 are located, a particular entity associated with the managed network 110, a particular device group, a user group, a role of users associated with the endpoints 106, other election criteria, or combinations thereof. In some embodiments, the subroutines 202 may include multiple election criteria 208 or a single election criterium 208. For instance, the election criteria 208 of a first subroutine may include an update being available for a first product of the products 115. The election criteria 208 of a second subroutine may include a vulnerability score of an outstanding update being above a particular threshold and the endpoints 106 being in a particular jurisdiction. Additionally, in some embodiments, the election criteria 208 may include a change to one or more components of the managed network 110. For instance, the election criteria 208 might include an addition of a group of endpoints 106, an addition or removal of one or more of the products 115, etc. In these and other embodiments, the change to one or more components of the managed network 110 initiates the update operations 212.

The cadence 214 determines a frequency at which the subroutine 202 is active in a managed network 110. In some embodiments, the cadence 214 may be a regular interval at which the subroutine 202 is active such as a half-hourly cadence, an hourly cadence, a bi-daily cadence, a weekly cadence, a monthly cadence, a daily cadence, a quarterly cadence, etc. The cadence 214 may be related to a type of the election criteria 208, the update operations 212, or the subroutine 202. For instance, a first subroutine of the subroutines 202 may be defined to address critical or urgent vulnerabilities. Accordingly, the first subroutine may have a daily or an hourly cadence, for example, to ensure urgent vulnerabilities are addressed in the managed network 110. Additionally or alternatively, a second subroutine of the subroutines 202 may be configured to address regular or ordinary product updates, which may be published once per month or twice per quarter. Accordingly, the second subroutine may have a monthly cadence. The managed network 110 may implement the first and the second subroutines concurrently as described with reference to FIG. 2B.

To define the subroutines, the administrator 117 may provide the admin input 210 to the subroutine generator 150. The admin input 210 may include the election criteria 208, the update operations 212, the cadence 214, or some combination thereof for one or more or each of the subroutines 202.

In some embodiments, each of the subroutines 202 may be defined together or within one interaction with the subroutine generator 150. In some embodiments, a first subset of the subroutines 202 may be defined during a first interaction and a second subset of the subroutines 202 may be defined during a second, later interaction. For instance, the administrator 117 may communicate the admin input 210 to define three subroutines 202. These subroutines 202 may be concurrently implemented for months or years to manage the managed network 110. The administrator 117 may then add an additional subroutine 202 to optimize or modify management of the managed network 110.

The admin input 210 may be received by a definition module 204 of the subroutine generator 150. For instance, the definition module 204 may include subroutine rules 206. The subroutine rules 206 may provide a background or a framework that enables the reception of and provides structure to the admin input 210. The subroutine rules 206 may provide options of combinations of subroutine parameters (e.g., the election criteria 208, the update operations 212, and the cadence 214) and/or available pre-configured parameters and combinations thereof. In some embodiments, the subroutine rules 206 may enable selection of the parameters by the administrator 117.

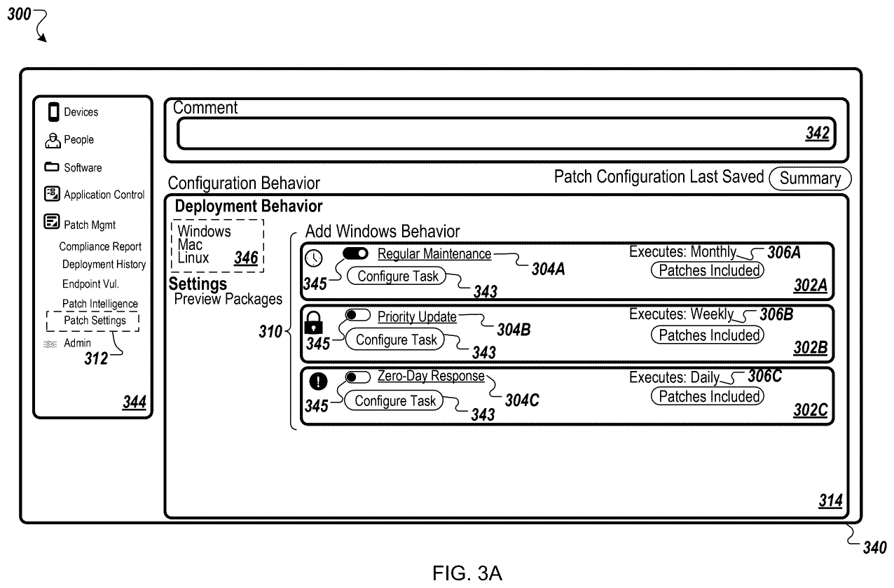

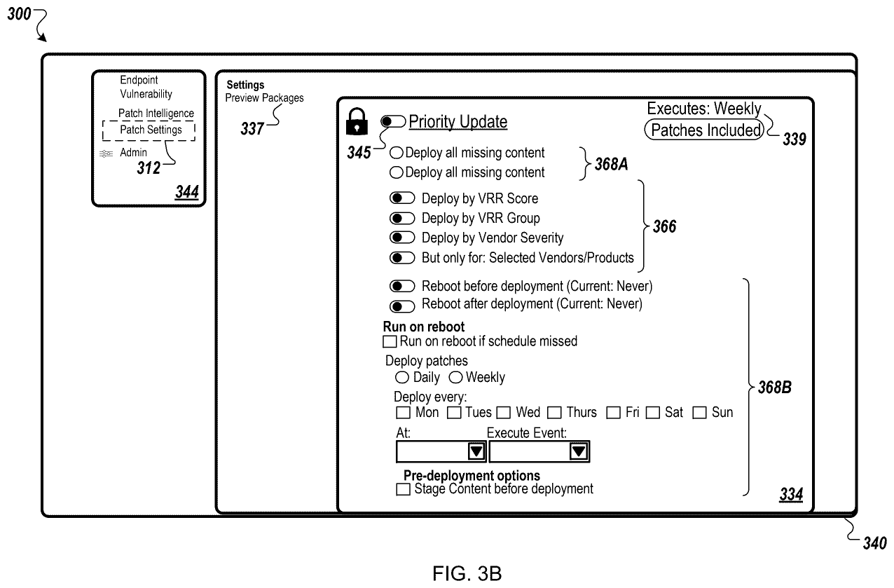

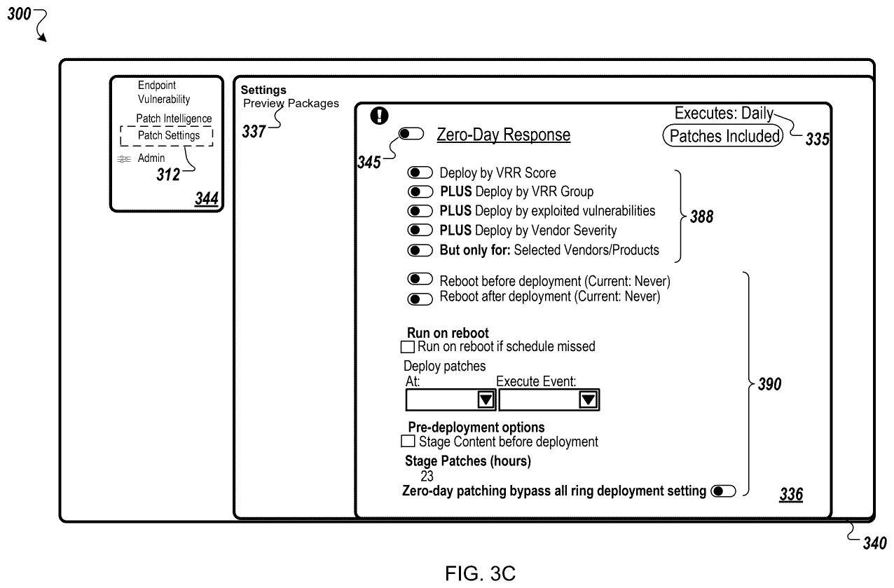

In some embodiments, the subroutine rules 206 may be incorporated into a user interface (UX). The admin input 210 may be entered into the user interface to define the subroutines 202. For example, FIGS. 3A-3C include an example UX 300 that includes an example set of subroutine rules 206. The UX 300 may be displayed by the definition module 204 and enable the admin input 210 to be entered or otherwise communicated to the subroutine generator 150. In general, the UX 300 displays one or more rules pertaining to the election criteria 208, the update operations 212, and the cadence 214 available or recommended for the subroutines 202. The definition module 204 may receive, via the UX 300 or another UX, indications of selections of one or both of the election criteria 208 and the update operations 212. Some additional details of the UX 300 are provided elsewhere in the present disclosure.

After the admin input 210 is received by the definition module 204, the subroutine generator 150 may generate the two or more subroutines 202. For instance, the subroutines 202 may include a priority subroutine. The priority subroutine may be configured to address outstanding updates of one of the products 115 such as a web browser. The priority subroutine may include a first election criterium, a first update operation, and a first cadence. The first election criterium may include an outstanding product update for the web browser. For instance, if there is an outstanding product update for the web browser, the first update operation is initiated. The first update operation may include distribution of the outstanding product update for the web browser. The distribution may occur using the ring deployment. The first cadence may be a weekly cadence. Accordingly, every week the priority subroutine may be active, which may include a scan of a content feed for an outstanding update for the web browser. In response to there being an outstanding update for the web browser, the outstanding update may be distributed to the web browser application at the endpoints 106.

The subroutines 202 may also include a zero-day response subroutine that includes a second election criterium, a second update operation, and a second cadence. The second election criterium may be an outstanding product update that addresses a vulnerability of a particular severity. For instance, if the content feed includes an outstanding update having a VRR score above 9.6, the second update operation may be initiated. The second update operation may include distribution of a patch for the vulnerability within a particular time relative to the endpoints 106 in a particular geographic area. The second cadence may be a daily cadence. Accordingly, each day the content feed may be scanned for outstanding updates having the VRR score above 9.6. If the outstanding update is detected, then the patch is distributed to the identified endpoints 106 within the geographic area. The subroutines 202 may also include a maintenance subroutine that includes a third election criterium, a third update operation, and a third cadence. The third election criterium may include outstanding product updates in one or more other products 115 aside from the web browser. The third update operation includes distribution of the outstanding product updates according to a ring deployment process. The third cadence may be a monthly cadence. Accordingly, each month the content feed is scanned and outstanding updates are distributed. Other subroutines 202 are definable. The subroutines 202 described above are examples.

The subroutines 202 may be communicated to the patch database 152 and the security engine 141. The subroutines 202 may be stored in the patch database 152. Accordingly, the security engine 141, the subroutine generator 150, and the subroutine generator 150 may access the subroutines 202. For instance, the administrator 117 may later access the subroutines 202 to modify one or more of the subroutines 202. Additionally or alternatively, the security engine 141 may access the subroutines 202 during implementation. Additionally or alternatively, the subroutine generator 150 may use the subroutines 202 to modify the subroutine rules 206 such as generating a template etc. therefrom.

The security engine 141 may include a schedule module 220. The schedule module 220 may review the subroutines 202 and specifically the cadences 214 of the subroutines 202. The schedule module 220 may be configured to generate a cadence schedule 218. The cadence schedule 218 includes the cadences 214 of each of the subroutines 202. The cadence schedule 218 combines and arranges the cadences 214 over a period of time (e.g., a year or a month) such that some of the subroutines 202 are active and other subroutines 202 are inactive each day according to the cadences 214. For instance, in an embodiment including the priority subroutine, the zero-day subroutine, and the maintenance subroutine, the cadence schedule 218 may indicate that the zero-day subroutine is active every day, the priority subroutine is active one day each week (e.g., the 7th, 14th, 21st, and 28th days of each month) and inactive every other day, and the maintenance subroutine may be active once a month (e.g., the 28th day of each month) and inactive every other day. Accordingly, the subroutines 202 implemented to manage the managed network 110 are arranged relative to one another over the period of time.

The cadence schedule 218 may be communicated to an implementation module 216. To concurrently implement the subroutines 202, the implementation module 216 may use the cadence schedule 218 to determine which of the subroutines 202 are active on a particular date and time. For instance, the implementation module 216 may scan the content feed and/or the components of the managed network 110 for the election criteria 208 of the active subroutines 202 as is described with reference to FIG. 2B.

In some embodiments, the admin input 210 may include a triggering criterium 294. In these and other embodiments, the triggering criterium may be defined for one or more of the subroutines 202. The triggering criterium may include an event or a network status change in the managed network 110 that may activate one or more of the subroutines 202. For instance, in some implementations instead of the cadence 214 causing activation of the subroutine 202, the triggering criterium 294 may be used to activate the subroutine 202. Additionally or alternatively, one of the subroutines 202 may be activated by either the triggering criterium 294 or the cadence 214. The triggering criterium 294 may include addition or removal of one or more of the endpoints 106, addition or removal of the products 115, movement of one or more of the endpoints 106 (e.g., between jurisdictions 123), changes in associations between one or more of the endpoints 106 and one or more of the users 113, changes to network conditions or security settings, changes in a role or security clearance of one or more of the users 113, an exploited vulnerability in the managed network 110, a behavior indicative of malicious activity in the managed network 110, other triggering criteria, or combinations thereof.

For example, a first subroutine (e.g., 202) may be defined to include a first election criteria (208) that is a patch for a vulnerability that affects one or more of the products 115, a first update operation (212) that is distribution of the patch to the endpoints 106 outside of a ring deployment scheme, and a first triggering criterium (294) that includes quarantine of one or more of the endpoints 106. Accordingly, the first subroutine may be activated responsive to detection of the quarantine of the endpoints 106 regardless of the time or date. Additionally, a second subroutine (202) may include the first election criteria, the first update operation 212, the first triggering criterium as well as a first cadence 214 that is a daily cadence. Accordingly, the second subroutine may be activated every day and be activated responsive to the quarantine of one or more of the endpoints 106. The subroutines 202 including the triggering criterium 294 may be included with other subroutines 202 and communicated to the security engine 141 for concurrent implementation. Some additional details of activation of these subroutines 202 are provided with reference to FIG. 2B.

FIG. 2B is a block diagram of an implementation phase 201B of the process 200. During the implementation phase 201B, the two or more subroutines 202 are concurrently implemented to manage the managed network 110. As used herein, concurrent implementation indicates that the subroutines 202 defined in the setup phase 201A are prepared and/or staged for implementation by the implementation module 216. The subroutines 202 may be active (or scheduled to run) according to the cadence 214 of each of the subroutines 202. Some days, one or multiple subroutines 202 may be active and accordingly, the one or the multiple subroutines 202 may run that day. On other days, no subroutines 202 may be active and thus, none of the subroutines 202 may run on these days. Each day the implementation module 216 determines, based on the cadence schedule 218 which of the subroutines 202 are active and which are inactive. The implementation module 216 then implements the subroutines 202 that are active and does not implement the subroutines 202 that are inactive.

Concurrent implementation in the implementation phase 201B may be performed by the security engine 141. In the embodiment of FIG. 2B, the security engine 141 includes the schedule module 220, an update module 224, and the implementation module 216 introduced above. The implementation module 216 includes a scan module 230, a determination module 226, and an execution module 228.

The scan module 230, the determination module 226, and the execution module 228 may have access to a content feed 222, the cadence schedule 218, and the subroutines 202.

The content feed 222 may include one or more items from the update list 125, which may be received or accessed from a third-party system 116. The content feed 222 may include a catalog of items from the update list 125 (e.g., outstanding product updates) along with metadata associated with the outstanding product updates, links to the product updates, or combinations thereof. The metadata might include, for instance, information to identify one of the products 115 related to a product update, an applicable version the product 115, information indicative of analysis of an outstanding product update such as a vulnerability score, a severity of the product update, a success rate of the product update, a vulnerability aggregation score, a configuration, an update name, a match string, and the like. In some embodiments, one or more portions of the metadata may be pulled from another engine of the SAAS management engines 109. For instance, the vulnerability aggregation information may be generated by a risk-based vulnerability management engine such as Ivanti® vulnerability management and prioritization engines (e.g., RiskSense®). The vulnerability aggregation information may be associated with outstanding product updates in the content feed 222. The content feed 222 is updated regularly. For instance, the content feed 222 may be updated each time or nearly every time there is a change to the update lists 125.

After the content feed 222 is updated and received at the implementation module 216, the determination module 226 may access the cadence schedule 218. The determination module 226 may determine which of the subroutines 202 is active according to the cadence schedule 218. For instance, each day the determination module 226 may review the cadence schedule 218 to ascertain which of the subroutines 202 are active that day and which of the subroutines are inactive.

The determination of the active subroutines 202 may be made at a time in which the content feed 222 is received or after the content feed 222 is received. In some embodiments, the determination may be made between receipt of the content feed 222 and a subsequently updated content feed 222.

For each subroutine 202 that is not active or inactive by the determination module 226, the determination module 226 may not initiate a scan operation by the scan module 230. Accordingly, the subroutines 202 that are not active, no scan is implemented.

For each subroutine 202 that is active, the determination module 226 may communicate the subroutines 202 to the scan module 230. The scan module 230 may receive the subroutines 202 that are active and scan the content feed 222 and/or components of the managed network 110. The scan may be performed to search for the election criteria (e.g., election criteria 208 of FIG. 2A) identified in the definition of the subroutine 202. For example, the election criteria of one of the subroutines 202 that are active may include an outstanding update for a first product of the products 115. The scan module 230 may scan the content feed 222 to determine whether the content feed 222 includes the outstanding update for the first product.

In response to the scan module 230 not finding the election criteria in the content feed 222, the scan module 230 may cease update operations or otherwise not perform the update operations. In some embodiments, the scan module 230 may generate or communicate a notification to the administrator 117 indicating that the scan is performed, but no election criteria is found.

In response to the scan module 230 finding the election criteria in the content feed 222, the scan module 230 may communicate to the execution module 228 that the election criteria are present in the content feed 222, to perform the update operation in the active subroutine.

Based on the active subroutine 202 and an indication that the election criteria are present in the content feed 222, the execution module 228 may perform one or more of the update operations (e.g., 212 of FIG. 2B). For instance, the execution module 228 may identify which of the endpoints 106 receive a product update. For example, the execution module 228 may identify the endpoints 106 based on the jurisdiction 123 of the endpoints 106, a device group, a user group, etc. The execution module 228 may further set a timeline for update distribution, may turn on or turn off ring deployment, and the like. The execution module 228 may then communicate instructions to the update module 224 related to which of the endpoints 106 and the products 115 that receive product updates.

The update module 224 may generate update packages 232. The update packages 232 include information and data used to implement the product update at the endpoints. The update module 224 may then distribute the update packages 232 to the endpoints 106 for implementation. Implementation of the update packages 232 may modify or change a state or setting of one of the products 115. For example, the update packages 232 may include scripts, instructions, and the like that are executed by the agent 121 to download and/or execute installation of a patch or a product update at the endpoints 106.

The content feed 222 may be updated to generate an additional content feed that includes additional outstanding product updates and update metadata. The determination module 226 may determine, at a time in which the additional content feed is received, which of the subroutines 202 are active according to the cadence schedule. The scan module 230, the execution module 228, the update module 224 may repeat the operations above based on the presence or absence of election criteria in the active subroutines 202. The execution module 228 may perform update operations and the update module 224 may generate update packages 232, which may be implemented at the endpoints 106 identified by the active subroutines 202.

For example, the zero-day subroutine and the priority subroutine described above may be implemented in the implementation phase 201B. The zero-day subroutine may be active every day, and the priority subroutine may be active once a week (e.g., the 1^{st}, 8^{th}, 15^{th}, and 22^{nd}). In this example, the content feed 222 may be received on the 1^{st} of the month. The determination module 226 may determine that the zero-day subroutine and the priority subroutines are active. The scan module 230 may scan the content feed 222 from a vulnerability having a score above 9.6 and for updates for the web browser. Responsive to an update to the web browser being present in the content feed, the execution module 228 and the update module 224 may generate an update package for the web browser and distribute it. The scan module 230 may not find the vulnerability with a score above 9.6, so no update package is generated related to the zero-day subroutine.

On the 2^{nd} of the month, an updated version of the content feed 222 may be received. The priority subroutine is not active, but the zero-day subroutine may be active on the second of the month. Accordingly, the scan module 230 may scan the additional content feed for the vulnerability with a score over 9.6, but not for the web browser update. If there is not a vulnerability with a score over 9.6, no additional update actions are performed.

On the 3^{rd} of the month, an updated version of the content feed 222 may be received. The priority subroutine is not active, but the zero-day subroutine may be active on the third of the month. Accordingly, the scan module 230 may scan the additional content feed for the vulnerability with a score over 9.6, but not for the web browser update. If there is a vulnerability with a score over 9.6, the execution module 228 and the update module 224 may generate the update package 232 and distribute it to the product 115 and the endpoint affected by the vulnerability.

In some embodiments, one or more or a subset of the subroutines 202 may be defined to include the triggering criterium. In these and other embodiments, concurrent implementation of the subroutines 202 may include receipt of an event indication 296. The event indication 296 may be received from the endpoints 106 (e.g., the agent 121 of the endpoints 106) or from one or more of the SAAS management engines 109. The event indication 296 may indicate that the triggering criterium is present or has occurred in the managed network 110.

Responsive to the event indication 296, the determination module 226 may be configured to determine that one or more or a subset of the subroutines 202 are active. For each subroutine 202 the scan module 230 may scan the content feed 222 for the election criteria identified in the definition of the subroutine 202. Responsive to the election criteria being present in the content feed 222, the execution module 228 may perform the update operation(s) in the definition of the subroutine 202. In the absence of the event indication 296, the implementation module 216 may perform the concurrent implementation of the subroutines 202 according to the cadence schedule 218.

FIGS. 3A-3C include an example UX 300 that may be implemented in the setup phase 201 of the process 200 of FIG. 2A. The UX 300 includes an example set of subroutine rules, which are an example of the subroutine rules 206 of FIG. 2A. The UX 300 may be displayed by a definition module such as the definition module 204 of FIG. 2A. The UX 300 enables entry of admin input to generate one or more of the subroutines 202 described elsewhere in the present disclosure. In general, the UX 300 displays one or more rules pertaining to the election criteria 208, the update operations 212, and the cadence 214 available or recommended for the subroutines 202. The definition module 204 may receive, via the UX 300, indications of selections of one or both of the election criteria 208 and the update operations 212.

Portions of the UX 300 are shown in each of FIGS. 3A, 3B, and 3C. FIG. 3A depicts a summary page 314 in which the multiple subroutine windows 310 are depicted. FIG. 3B depicts a first input page 334 for a priority subroutine 302B. FIG. 3C depicts a second input page 336 for a zero-day response subroutine 302C.

Referring to FIG. 3A, the summary page 314 is depicted within an update management interface 340. The update management interface 340 includes the summary page 314 below a comment window 342 and a navigation window 344. To display the summary page 314 in the update management interface 340, a ‘patch setting’ navigation icon 312 may be selected in the navigation window 344.

An operating system (OS) selection portion 346 may be included in the summary page 314. The OS selection portion 346 enables selection of an OS for one or more endpoints (e.g., endpoints 106). Selection of ‘Windows®’ enables configuration of subroutines 302A-302C for endpoints running Windows OS. Selection of Mac or Linux enables configuration of subroutines for endpoints running Mac or Linux OS, respectively. In the depicted embodiment, Windows OS has been selected, such that the summary page 314 includes the subroutines 302A-302C for endpoints running Windows OS. The OS selection portion 346 may be an example of an initial parameter, which may characterize a subset of the endpoints of the managed network to which the subroutines are applicable.

In the summary page 314, the subroutine windows 310 are displayed. In the depicted embodiments, there are three subroutine windows 310 displayed in the summary page 314. The subroutine windows 310 include a first window for a regular maintenance subroutine 302A, a second window for the priority subroutine 302B, and a third window for the zero-day response subroutine 302C. Each of the subroutine windows 310 includes a title 304A-304C, a cadence indicator 306A-306C, a selector switch 345, and a configuration button 343. For instance, for the maintenance subroutine 302A, a first title 304A includes “Regular Maintenance,” and a first cadence indicator 306A includes “Monthly.” Similarly, for the priority subroutine 302B a second title 304B includes “Priority Update” and a second cadence indicator 306B includes “Weekly.” Selection of the selector switch 345 actuates the subroutine 302A-302C. For instance, in FIG. 3A, the regular maintenance subroutine 302A is active. The priority subroutine 302B and the zero-day response subroutine 302C are not active. Selection of the configuration button 343 enables input of admin input to define the subroutine 302A-302C.

FIG. 3B includes the first input page 334 in the update management interface 340. The first input page 334 may be displayed responsive to selection of the configuration button 343 in the subroutine window 310 for the priority subroutine 302B in FIG. 3A. In the first input page 334, multiple election criteria selections 366 are presented along with multiple update operations 368A and 368B (generally, update operation 368 or update operations 368) are presented. For instance, the election criteria selections 366 include “deploy by VRR score,” “deploy by VRR group,” “deploy by vendor group,” and “but only for: Selected Vendors/Products.” Admin input may include selection of one or more of the election criteria selections 366. For instance, an administrator may select “deploy by VRR score,” which may define an election criterium as a VRR score of an update in a content feed. Similarly, selection of “But only for: Selected Vendors/Products” and input of a specific vendor or a specific product may define an election criterium as an update from the specific vendor in the content feed.

The multiple update operations 368 include “deploy all missing content” a “run on reboot” option, timing related to patch deployment, and pre-deployment options. Accordingly, admin input may define update operations to include reboot configurations, timing of deployment, staging options, and the like.

In addition, first input page 334 includes a cadence indicator 339, the selector switch 345, and a preview packages link 337. Selection of the cadence indicator 339 may enable modification of the cadence for the priority subroutine 302B in some embodiments. In other embodiments, the cadence may be pre-defined. The selector switch 345 may activate the priority subroutine 302B such that it is concurrently implemented. The preview packages link 337 may enable review of update packages generated using the priority subroutine 302B.

FIG. 3C includes the second input page 336 in the update management interface 340. The second input page 336 may be displayed responsive to selection of the configuration button 343 in the subroutine window 310 for the zero-day response subroutine 302C in FIG. 3A. In the second input page 336, multiple election criteria selections 388 are presented along with multiple update operations 390 are presented. For instance, the election criteria selections 388 include “deploy by VRR score,” “PLUS deploy by VRR group,” “PLUS deploy by exploited vulnerabilities,” “PLUS Deploy by Vendor Severity” and “but only for: Selected Vendors/Products.” Admin input may include selection of one or more of the election criteria selections 388. For instance, an administrator may select “Deploy by VRR score,” and the “PLUS Deploy by Vendor Severity” may be selected. Accordingly, the admin input may define one of the election criteria as a VRR score and a Vendor Severity of an update in a content feed.

The update operations 390 of the second input page 336 include a “run on reboot” option, timing related to patch deployment, pre-deployment options and staging timing, and ring deployment bypass options. Accordingly, admin input may define update operations to include reboot configurations, timing of deployment, staging options, ring deployment options, and the like.

In addition, second input page 336 includes a cadence indicator 335, the selector switch 345, and the preview packages link 337. Selection of the cadence indicator 335 may enable modification of the cadence for the zero-day response subroutine 302C in some embodiments. In other embodiments, the cadence may be pre-defined. The selector switch 345 may activate the zero-day response subroutine 302C such that it is concurrently implemented. The preview packages link 337 may enable review of update packages generated using the zero-day response subroutine 302C.

FIG. 4 illustrates an example computer system 400 configured for concurrent subroutine implementation, according to at least one example of the present disclosure. The computer system 400 may be implemented in the operating environment 100 FIG. 1, for instance. Examples of the computer system 400 may include the management device 104, one or more of the endpoints 106, the third-party system 116, or some combination thereof. The computer system 400 may include one or more processors 410, a memory 412, a communication unit 414, a user interface device 416, and a data storage 404 that may include the SAAS management engine 109, the security engine 141, the subroutine generator 150, the products 115, the agent 121, or some combination thereof (collectively, modules 450).

The processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, the processor 410 may more generally include any number of processors configured to perform individually or collectively any number of operations described in the present disclosure. Additionally, one or more of the processors 410 may be present on one or more different electronic devices or computing systems. In some examples, the processor 410 may interpret and/or execute program instructions and/or process data stored in the memory 412, the data storage 404, or the memory 412 and the data storage 404. In some examples, the processor 410 may fetch program instructions from the data storage 404 and load the program instructions in the memory 412. After the program instructions are loaded into the memory 412, the processor 410 may execute the program instructions.

The memory 412 and the data storage 404 may include computer-readable storage media for carrying or having computer-executable instructions or data structures stored thereon. Such computer-readable storage media may include any available media that may be accessed by a general-purpose or special-purpose computer, such as the processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

The communication unit 414 may include one or more pieces of hardware configured to receive and send communications. In some examples, the communication unit 414 may include one or more of an antenna, a wired port, and modulation/demodulation hardware, among other communication hardware devices. In particular, the communication unit 414 may be configured to receive a communication from outside the computer system 400 and to present the communication to the processor 410 or to send a communication from the processor 410 to another device or network (e.g., the network 120 of FIG. 1).

The user interface device 416 may include one or more pieces of hardware configured to receive input from and/or provide output to a user. In some examples, the user interface device 416 may include one or more of a speaker, a microphone, a display, a keyboard, a touch screen, or a holographic projection, among other hardware devices.

The modules 450 may include program instructions stored in the data storage 404. The processor 410 may be configured to load the modules 450 into the memory 412 and execute the modules 450. Alternatively, the processor 410 may execute the modules 450 line-by-line from the data storage 404 without loading them into the memory 412. When executing the modules 450, the processor 410 may be configured to perform one or more processes or operations described elsewhere in this disclosure.

Modifications, additions, or omissions may be made to the computer system 400 without departing from the scope of the present disclosure. For example, in some examples, the computer system 400 may not include the user interface device 416. In some examples, the different components of the computer system 400 may be physically separate and may be communicatively coupled via any suitable mechanism. For example, the data storage 404 may be part of a storage device that is separate from a device, which includes the processor 410, the memory 412, and the communication unit 414, that is communicatively coupled to the storage device. The examples described herein may include the use of a special-purpose or general-purpose computer including various computer hardware or software modules, as discussed in greater detail below.

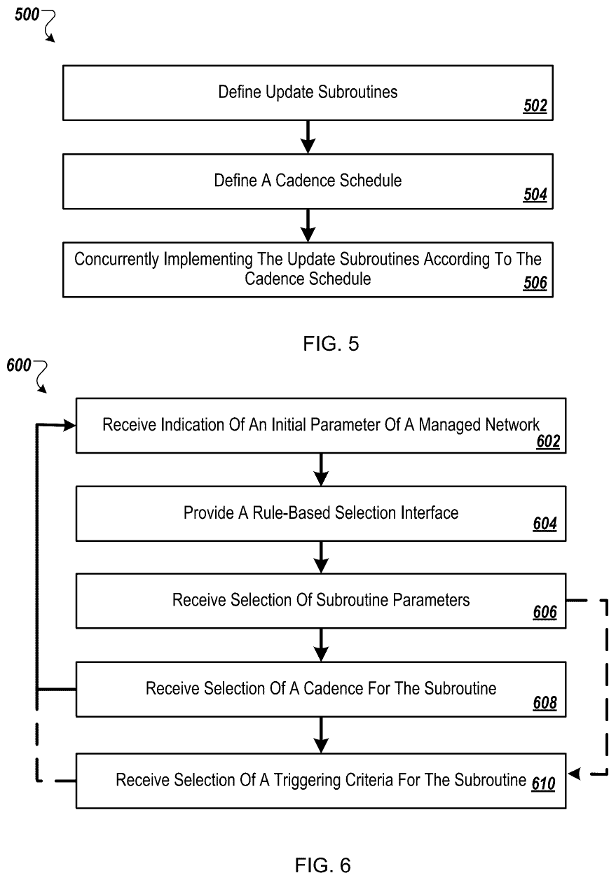

FIG. 5 is a flow chart of an example method 500 of concurrent, multi-cadence update management, according to at least one embodiment of the present disclosure. The method 500 may be implemented in a managed network such as the managed network 110 of FIGS. 1-2B. The method 500 may begin at block 502 in which one or more subroutines may be defined. One or more of the subroutines include an update operation, an election criterium, and a cadence; an update operation, an election criterium, and a triggering criterium, or an update operation, an election criterium, an election criterium and a triggering criterium. The update operation includes distribution or deployment of product updates. The election criterium is a condition or characteristic that initiates the update operation. The cadence determines a frequency at which the subroutine is active in the managed network. The triggering criterium includes an event or a network status change in the managed network that activates the subroutine. Some additional details of an example subroutine definition process are described with reference to FIG. 6.

For instance, the defined subroutines may include a priority subroutine. The priority subroutine may include a first election criterium, a first update operation, and a first cadence. The first election criterium may be an outstanding product update for a particular product such as a web browser application, or a software application provided by a particular vendor. The first update operation may include distribution of the outstanding product update for the particular product. The first cadence may be a weekly cadence. The defined subroutines may also include a zero-day response subroutine that includes a second election criterium, a second update operation and a second cadence the second election criterium may include an outstanding product update that addresses a vulnerability of a particular severity (e.g., a particular VRR score or vendor severability. The second update operation may include distribution of a patch for the vulnerability within a particular time. The second cadence may include a daily cadence. The subroutines may further include a maintenance subroutine that includes a third election criterium, a third update operation, and a third cadence. The third election criterium may include outstanding product updates in one or more other products aside from the particular product. The third update operation may include distribution of the outstanding product updates according to a ring deployment process. The third cadence may include a monthly cadence.

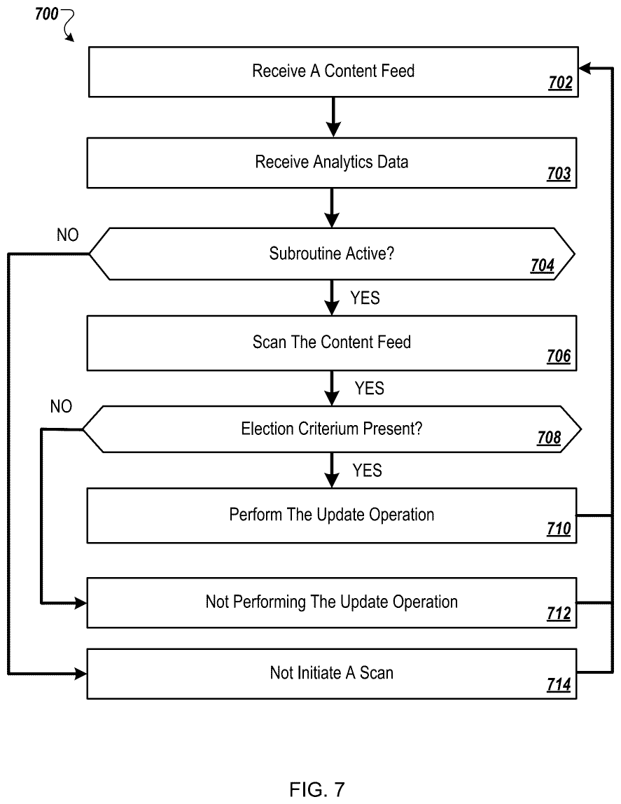

At block 504, a cadence schedule may be defined. The cadence schedule may include each of the cadences of each subroutine of the multiple defined subroutines. For instance, from the example above, there may be a daily, weekly, and monthly cadence, which are included in the cadence schedule. At block 506, the subroutines may be concurrently implemented. Concurrent implementation of the updated subroutines may be performed for months, years, or indefinitely in some embodiments. The concurrent implementation may include management of updates in the managed network according to the cadence schedule, the triggering criterium, and the defined subroutines. For instance, scans may be performed for the election criteria each time one or more of the defined subroutines becomes active according to the cadence schedule and/or responsive to receipt of an indication of the triggering criterium. Product updates may be distributed and deployed with minimal or no intervention of an administrator. Accordingly, even in circumstances in which an urgent vulnerability is defined, the concurrent implementation may determine patch distribution to address the urgent vulnerability. Some additional details of an example concurrent implementation are described with reference to FIG. 7.

FIG. 6 is an example method 600 of subroutine definition according to at least one embodiment of the present disclosure. The method 600 may be incorporated in another method such as the method 500 of FIG. 5. For instance, the method 600 may be performed in block 502 of FIG. 5. The method 600 may be performed two or more times to define multiple subroutines. The method 600 may be performed two or more times prior to concurrent implementation of the subroutines. An example of concurrent implementation of two or more subroutines may be as described in method 700 of FIG. 7.

The method 600 may begin at block 602 in which an indication of an initial parameter is received. The initial parameter may characterize a subset of endpoints of a managed network to which the subroutines are applicable. For instance, the initial parameter may include an operating system implemented by the endpoints.

At block 604, a rule-based selection interface may be provided. The rule-based selection interface may be provided in a user interface. The rule-based selection interface may include one or more rules that pertain to parameters of one or both of election criteria and update operations that may be included in a first subroutine. For instance, the rules may enable selection of one or more update operations and/or one or more election criteria that initiates the update operation(s) for the first subroutine. At block 606, selections of subroutine parameters may be received. For instance, selection of a first election criteria and a first update operation for a first subroutine may be received. Additionally, selections of a second election criteria and a second update operation for a second subroutine may be received. In some embodiments, selections may be received in rule-based selection interface, which may be displayed or caused to be displayed to an administrator.

In some embodiments, the update operation may identify a subset of managed endpoints that are updated, may specify a jurisdiction in which managed endpoints are updated, may dictate whether an update is distributed according to a ring deployment process, a reboot operation, another update operation, or combinations thereof. The election criterium may include an identified product, an update with a particular characteristic of a product update, the particular characteristic includes a vulnerability score, a device group, a deployment schedule, another election criterium, or combinations thereof. In some embodiments, the election criterium may be related to analytics data related to the content feed. For instance, the election criterium may include an exploit vulnerability included in the analytics data.

The method 600 may proceed to block 608, to block 610 (e.g., omit block 608), or to both blocks 608 and 610. At block 608, a selection of a cadence for the subroutine may be received. The selection of the cadence indicates when the subroutine is active. The cadence may include a half-hourly cadence, an hourly cadence, a weekly cadence, a monthly cadence, a daily cadence, a quarterly cadence, or another suitable cadence. After block 608, the method 600 may proceed to block 610 or to block 602 (e.g., omit block 610). From block 602, the method 600 may proceed through blocks 604, 606, 608, 610, or combinations thereof until the subroutines are defined for the managed network. At block 610, a selection of a triggering criterium for the subroutine may be received. The selection of the triggering criterium indicates an event or a network status change that may activate the subroutine. After block 610, the method 600 may proceed to block 602. From block 602, the method 600 may proceed through blocks 604, 606, 608, 610, or combinations thereof until the subroutines are defined for the managed network. After performance of the method 600, one or more subroutines may be defined. After the subroutines are defined, the defined subroutines may be concurrently implemented in a managed network.

In some embodiments, a portion of or a template for one or more subroutines may be provided. The template may be provided in the rule-based selection interface in some embodiments. The template may provide at least some of the components of at least one of the subroutines. For instance, a first template may be for a priority subroutine. The priority subroutine may include the cadence and enable selection of the election criterium and the update operation.

FIG. 7 is an example method 700 of concurrently implementing two or more subroutines according to at least one embodiment of the present disclosure. The method 700 may be performed in a managed network in which two or more subroutines are defined. For instance, the method 700 may be implemented in managed networks following definitions of two or more subroutines, which may occur according to the method 600 or another suitable method. The method 700 may be incorporated in another method such as the method 500 of FIG. 5. For instance, the method 700 may be performed in block 506 of FIG. 5 in some embodiments.

The method 700 may begin at block 702 in which a content feed is received. The content feed may include an enumeration or a set of outstanding product updates and/or update metadata that may be associated with one or more of the outstanding product updates. In some embodiments, the method 700 may proceed to block 703 in which analytics data may be received. The analytics data may include risk-based vulnerability analytics data such as exploit vulnerability data. For example, the analytics data may include prioritization and remediation information related to the one or more outstanding product updates. In some embodiments, the method 700 may not include block 703. For instance, in some embodiments, one or more of the subroutines may include an election criterium that is based on the analytics data. In these and other embodiments, the analytics data of block 703 may be received. In some embodiments in which the election criterium is not based on the analytics data, block 703 may be omitted from the method 700.

At block 704, it may be determined whether one or more subroutines are active. For instance, whether the subroutines are active may be determined based on a cadence schedule. The cadence schedule includes two or more cadences of the two or more subroutines over a defined period. For instance, there may be three subroutines implemented in a managed network such as a first subroutine having a monthly cadence, a second subroutine having a weekly cadence, and a third subroutine having a daily cadence. In this example, a defined period of the cadence schedule may be a month and may include the monthly cadence of the first subroutine, the weekly cadence of the second subroutine, and the daily cadence of the third subroutine. The content feed may be received on the 28th of February, which may be the end of the month, and the end of a week. Accordingly, all three of the subroutines may be active. In contrast, the content feed may be received on the 27th of February, which is not the end of the month or the end of the week. Accordingly, only the third subroutine (i.e., having the daily cadence) may be active. The determination of block 704 may be performed at a time in which the content feed is received or at a time after the content feed is received. In some embodiments, the determination may be made after the content feed is received but prior to a subsequent content feed is received.

Additionally or alternatively, the determination of whether the subroutine is active may be based on an indication of a triggering criterium. For instance, the indication of the triggering criterium may be received that is defined in one of the subroutines. Responsive to receipt of the indication, it may be determined that a corresponding subroutine is active.

In response to the subroutine being active (“YES” at block 704), the method may proceed to block 706. In response to the subroutine not being active (“NO” at block 704), the method may proceed to block 714. At block 706, the content feed may be scanned. For instance, for each subroutine that is active the content feed may be scanned for an election criterium identified in the definition of the subroutine. Additionally or alternatively, the analytics data may be scanned for the election criterium identified in the definition of the subroutine. At block 708, it may be determined whether the election criterium is present. For instance, the election criterium may include an outstanding product update for a particular product or an outstanding product update with a particular VRR range. The scan may be performed to identify the presence of the election criterium in the content feed and/or the analytics data. In response to the election criterium being present (“YES” at block 708), the method may proceed to block 710. In response to the election criterium not being present (“NO” at block 708), the method may proceed to block 712. At block 710, the update operation may be performed. The update operation may be included in the definition of the subroutine and may be performed responsive to the election criterium being present in the content feed and/or the analytics data.

Blocks 712 and 714 are non-operational actions. For instance, at block 714, a scan may not be initiated for each of the subroutines that is not active. For instance, responsive to the subroutine cadence not being on the cadence schedule, a scan operation may not be initiated for the subroutine. Similarly, at block 712, the update operation may not be performed. For instance, the election criterium of the subroutine is not present in the content feed and/or the analytics data.

After blocks 710, 712, and 714, the method 700 may proceed to block 702. One or more of blocks 702, 703, 704, 706, 708, 710, 712, and 714 may be repeated. For instance, an additional content feed and/or additional analytics data may be received (blocks 702 and 703). The additional content feed may include additional outstanding product updates and update metadata related to the additional outstanding product updates. The analytics data may relate to the additional outstanding product updates. At a time in which the additional content feed is received, it may be determined whether or which subroutines are active according to the cadence schedule (block 704). Responsive to the subroutine being active, scans of the content feed and/or the analytics data may be performed for the election criteria (block 706). For the subroutines not being active, a scan may not be performed (block 714). It may be determined whether an election criterium is present (block 708). Responsive to the election criterium being present in the additional content feed and/or the additional analytics data, the update operation may be performed (block 710). Responsive to the election criterium not being present in the additional content feed and/or the additional analytics data, the update operation may not be performed (block 712).

Further, modifications, additions, or omissions may be made to the methods 500, 600, and 700 without departing from the scope of the present disclosure. For example, the operations of methods 500, 600, and 700 may be implemented in differing orders. Furthermore, the outlined operations and actions are only provided as examples, and some of the operations and actions may be optional, combined into fewer operations and actions, or expanded into additional operations and actions without detracting from the disclosed examples.

The methods 500, 600, and 700 may be performed in a suitable operating environment such as the operating environment 100 or the managed network 110 of FIG. 1. The methods 500, 600, and 700 may be performed by the management device 104 described elsewhere in the present disclosure or by another suitable computing system, such as the computer system 400 of FIG. 4. In some examples, the management device 104 or the other computing system may include or may be communicatively coupled to a non-transitory computer-readable medium (e.g., the memory 412 of FIG. 4) having stored thereon programming code or instructions that are executable by one or more processors (such as the processor 410 of FIG. 4) to cause a computing system or the management device 104 to perform or control performance of the methods 500, 600, and 700. Additionally or alternatively, the management device 104 may include the processor 410 that is configured to execute computer instructions to cause the management device 104 or another computing systems to perform or control performance of the methods 500, 600, and 700. The management device 104 or the computer system 400 implementing the methods 500, 600, and 700 may be included in a cloud-based managed network, an on-premises system, or another suitable network computing environment. Although illustrated as discrete blocks, one or more blocks in FIGS. 5-7 may be divided into additional blocks, combined into fewer blocks, or eliminated, depending on the desired implementation.

The examples described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some examples, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modules running on a computing system.

The various features illustrated in the drawings may not be drawn to scale. The illustrations presented in the present disclosure are not meant to be actual views of any particular apparatus (e.g., device, system, etc.) or method, but are representations employed to describe examples of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one”and “one or more”to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although examples of the present inventions have been described in detail, it should be understood that the various changes, substitutions, and alterations could be made hereto without departing from the scope of the invention.

What is claimed is:

1. A method of concurrent, multi-cadence update management in a managed network, the method comprising:
defining a plurality of update subroutines, wherein each subroutine of the plurality of update subroutines includes an update operation, an election criterium that initiates the update operation, and a cadence that determines a frequency at which the subroutine is active in a managed network;
defining a cadence schedule that includes cadences of each subroutine of the plurality of update subroutines;
concurrently implementing the plurality of update subroutines, wherein the concurrently implementing includes:
receiving a content feed, wherein the content feed includes an enumeration of outstanding product updates and update metadata associated with one or more of the outstanding product updates;
determining, at a time in which the content feed is received, whether each of the plurality of update subroutines is active according to the cadence schedule;
for each subroutine of the plurality of update subroutines that is active:
scanning the content feed for an election criterium identified in a definition of the subroutine;
responsive to the election criterium being present in the content feed, performing the update operation in the definition of the subroutine; and
responsive to the election criterium not being present in the content feed, not performing the update operation in the definition of the subroutine.
for each subroutine of the plurality of update subroutines that is not active, not initiating a scan operation for the election criterium identified in the definition of the subroutine.

2. The method of claim 1, wherein:
the update operation identifies a subset of managed endpoints that are updated, specifies a jurisdiction in which managed endpoints are updated, dictates whether an update is distributed according to a ring deployment process, or specifies a reboot operation;
the election criterium includes an identified product, an update with a particular characteristic of a product update, the particular characteristic includes a vulnerability score, a device group, or a deployment schedule; and
the cadence includes a half-hourly cadence, an hourly cadence, a bi-daily cadence, a weekly cadence, a monthly cadence, a daily cadence, or a quarterly cadence.

3. The method of claim 1, wherein the election criteria include a change to one or more components of the managed network, the method further comprising for each subroutine of the plurality of update subroutines that is active, scanning the managed network for the change to one or more components of the managed network.

4. The method of claim 1, wherein:
the defining the plurality of update subroutines includes:
providing one or more rules in a user interface, the one or more rules pertaining to the election criterium and the update operation; and
receiving, via the user interface, indications of selections of one or both of the election criterium and the update operation; and
the defining the plurality of update subroutines includes receiving an indication the cadence for the subroutine.

5. The method of claim 1, wherein:
the plurality of update subroutines includes a priority update subroutine that includes:
a first election criterium that is an outstanding product update for a particular product;
a first update operation that includes distribution of the outstanding product update for the particular product; and
a first cadence that is a weekly cadence; or the plurality of update subroutines includes a zero-day response subroutine that includes:
a second election criterium that is an outstanding product update that addresses a vulnerability of a particular severity;
a second update operation that includes distribution of a patch for the vulnerability within a particular time; and
a second cadence that is a daily cadence.

6. The method of claim 5, wherein the plurality of update subroutines includes a maintenance subroutine that includes:
a third election criterium that includes outstanding product updates in one or more other products aside from the particular product;
a third update operation that includes distribution of the outstanding product updates according to a ring deployment process; and
a third cadence that is a monthly cadence.

7. The method of claim 1, wherein the concurrently implementing further includes:
receiving an additional content feed that includes additional outstanding product updates and update metadata;
determining, at a time in which the additional content feed is received, whether an additional update subroutine is initiated according to the cadence schedule; and
responsive to the additional update subroutine being initiated, performing a second scan of the content feed for the election criteria of the additional update subroutine and responsive to the election criteria of the additional update subroutine being present in the content feed, performing the update operation of the additional update subroutine.

8. The method of claim 1, further comprising receiving analytics data related to the content feed, wherein at least one election criterium is defined as an exploit vulnerability included in the analytics data.

9. The method of claim 1, further comprising defining a triggering criterium for a subset of subroutines of the plurality of update subroutines, wherein:
the triggering criterium is configured to activate the subset of subroutines; and
the triggering criterium includes an event or a network status change in the managed network.

10. The method of claim 9, wherein:
the concurrently implementing the plurality of update subroutines includes:
receiving an indication of the triggering criterium being present in the managed network;
responsive to the indication of the triggering criterium, determining that the subset of subroutines is active; and
for each subroutine of the subset of subroutines:
scanning the content feed for an election criterium identified in a definition of the subroutine;
responsive to the election criterium being present in the content feed, performing the update operation in the definition of the subroutine; and
responsive to the election criterium not being present in the content feed, not performing the update operation in the definition of the subroutine; and
the receipt of the indication occurs when the subset of subroutines is not active according to the cadence schedule.

11. A non-transitory computer-readable medium having encoded therein programming code executable by one or more processors to perform or control performance of operations of concurrent, multi-cadence update management in a managed network, the operations comprising:
defining a plurality of update subroutines, wherein each subroutine of the plurality of update subroutines includes an update operation, an election criterium that initiates the update operation, and a cadence that determines a frequency at which the subroutine is active in a managed network;
defining a cadence schedule that includes cadences of each subroutine of the plurality of update subroutines;
concurrently implementing the plurality of update subroutines, wherein the concurrently implementing includes:
receiving a content feed, wherein the content feed includes an enumeration of outstanding product updates and update metadata associated with one or more of the outstanding product updates;
determining, at a time in which the content feed is received, whether each of the plurality of update subroutines is active according to the cadence schedule;
for each subroutine of the plurality of update subroutines that is active:
scanning the content feed for an election criterium identified in a definition of the subroutine;
responsive to the election criterium being present in the content feed, performing the update operation in the definition of the subroutine; and
responsive to the election criterium not being present in the content feed, not performing the update operation in the definition of the subroutine.
for each subroutine of the plurality of update subroutines that is not active, not initiating a scan operation for the election criterium identified in the definition of the subroutine.

12. The non-transitory computer-readable medium of claim 11, wherein:
the update operation identifies a subset of managed endpoints that are updated, specifies a jurisdiction in which managed endpoints are updated, dictates whether an update is distributed according to a ring deployment process, or specifies a reboot operation;
the election criterium includes an identified product, an update with a particular characteristic of a product update, the particular characteristic includes a vulnerability score, a device group, or a deployment schedule; and
the cadence includes a half-hourly cadence, an hourly cadence, a bi-daily cadence, a weekly cadence, a monthly cadence, a daily cadence, or a quarterly cadence.

13. The non-transitory computer-readable medium of claim 11, wherein:
the defining the plurality of update subroutines includes:
providing one or more rules in a user interface, the one or more rules pertaining to the election criterium and the update operation; and
receiving, via the user interface, indications of selections of one or both of the election criterium and the update operation; and
the defining the plurality of update subroutines includes receiving an indication the cadence for the subroutine.

14. The non-transitory computer-readable medium of claim 11, wherein:
the plurality of update subroutines includes a priority update subroutine that includes:
a first election criterium that is an outstanding product update for a particular product;
a first update operation that includes distribution of the outstanding product update for the particular product; and
a first cadence that is a weekly cadence; or the plurality of update subroutines includes a zero-day response subroutine that includes:
a second election criterium that is an outstanding product update that addresses a vulnerability of a particular severity;
a second update operation that includes distribution of a patch for the vulnerability within a particular time; and
a second cadence that is a daily cadence.

15. The non-transitory computer-readable medium of claim 14, wherein the plurality of update subroutines includes a maintenance subroutine that includes:
a third election criterium that includes outstanding product updates in one or more other products aside from the particular product;
a third update operation that includes distribution of the outstanding product updates according to a ring deployment process; and
a third cadence that is a monthly cadence.

16. The non-transitory computer-readable medium of claim 11, wherein the concurrently implementing further includes:
receiving an additional content feed that includes additional outstanding product updates and update metadata;
determining, at a time in which the additional content feed is received, whether an additional update subroutine is initiated according to the cadence schedule; and
responsive to the additional update subroutine being initiated, performing a second scan of the content feed for the election criteria of the additional update subroutine and responsive to the election criteria of the additional update subroutine being present in the content feed, performing the update operation of the additional update subroutine.

17. The non-transitory computer-readable medium of claim 11, wherein the operations further comprise receiving analytics data related to the content feed, wherein at least one election criterium is defined as an exploit vulnerability included in the analytics data.

18. The non-transitory computer-readable medium of claim 11, wherein:
the election criteria include a change to one or more components of the managed network; and
the operations further comprise for each subroutine of the plurality of update subroutines that is active, scanning the managed network for the change to one or more components of the managed network.

19. The non-transitory computer-readable medium of claim 11, wherein:
the operations further comprise defining a triggering criterium for a subset of subroutines of the plurality of update subroutines;
the triggering criterium is configured to activate the subset of subroutines; and
the triggering criterium includes an event or a network status change in the managed network.

20. The non-transitory computer-readable medium of claim 21, wherein:
the concurrently implementing the plurality of update subroutines includes:
receiving an indication of the triggering criterium being present in the managed network;
responsive to the indication of the triggering criterium, determining that the subset of subroutines is active; and
for each subroutine of the subset of subroutines:
scanning the content feed for an election criterium identified in a definition of the subroutine;
responsive to the election criterium being present in the content feed, performing the update operation in the definition of the subroutine; and
responsive to the election criterium not being present in the content feed, not performing the update operation in the definition of the subroutine; and
the receipt of the indication occurs when the subset of subroutines is not active according to the cadence schedule.
